(19) United States
(12) Patent Application Publication
(10) Pub. No.: US 2011/0254505 A1
(43) Pub. Date: Oct. 20, 2011

(54) ELECTRICAL ENERGY CHARGING SYSTEM AND METHOD FOR CHARGING A VEHICLE

(75) Inventors: Andreas Evander, Onsala (SE); Martin Nyman, Malmo (SE)

(73) Assignee: EVOL TECHNOLOGY AB

(21) Appl. No.: 13/141,255

(22) PCT Filed: Dec. 22, 2009
(86) PCT No.: PCT/SE2009/051489

§ 371 Date: Jun. 21, 2011

(30) Foreign Application Priority Data
Dec. 22, 2008 (SE) 0802642-9

(51) Int. Cl. H02J 7/00

(52) U.S. Cl. 320/109

(57) ABSTRACT

The invention relates to an electrical energy charging system for a vehicle comprising a charging station (2) on a charging energy source side and a vehicle unit (12) on a charging energy receiver side. The system comprises: —an identification system for identification of a charging energy receiver identity (11); —a charging energy meter system comprising a first energy meter (5) on the charging energy source side and a second energy meter (6) on the charging energy receiver side for measuring outgoing charging energy Eₒᵤₜ from the charging energy source side and incoming charging energy Eᵢₙ to the charging energy receiver side, wherein the energy meters (5, 6) are constructed such that they create communicateable values comparable to each other and that they provide a reasonable estimation of the momentarily transferred energy; —a communication system for transfer of the charging energy receiver identity (11) and continuous transfer from the charging energy receiver side to the charging energy source side of data regarding amount of measured incoming charging energy on the charging energy source side for comparison with the outgoing charging energy measured at the charging energy source side, wherein the result of this comparison is decisive whether the charging energy source side shall continue to provide energy to the charging energy receiver side or not. The invention further relates to a method for charging an electrical vehicle, a charging station (2) for charging an electrical vehicle and a vehicle unit (12) to be used in an electrical vehicle.

### FIELD OF THE INVENTION

The present invention relates to an electrical energy charging system for a vehicle and a method for charging a vehicle. The invention further relates to a charging station for charging a vehicle and a vehicle unit to be used in a vehicle.

### BACKGROUND OF THE INVENTION

Vehicles of the electrical type or hybrid electrical type of so called plug-in model today demand long charging times compared to traditional refueling of liquid fuel such as petrol or diesel. There is thus a need to protect the charging against outside interference, for example theft or vandalism. When a charging is in process for several hours it is in many cases easy to manipulate the charging by moving the charging cable to another vehicle. This makes it more difficult for the electricity supplier to automatically be able to debit the delivered energy as it is not possible to securely determine which vehicle that has actually been charged. Present technology for refueling with liquid fuels is based on that the customer makes an active act on the spot to carry through the payment for the charging, and monitors the refueling such that it is not manipulated with. Both the payment and the monitoring of the charging process are desired to be simplified.

The object of the invention is thus to protect charging against manipulation, and to provide a system for charging which is easy to use and is secure. It is further an aim of the invention to simplify the procedure for payment of an accomplished charging.

### SUMMARY

These and other objects, which may appear from the description below, are at least partly achieved by means of an electrical energy charging system for a vehicle, a method for charging a vehicle, a computer readable medium, a charging station and a vehicle unit according to the independent claims. Embodiments thereof are defined by the dependent claims.

According to one aspect, the invention relates to a charging system comprising a vehicle unit for a vehicle with hardware and software and a charging station for electrical drive or hybrid electrical drive vehicles of so called plug-in-type, adapted to make the charging manipulation proof. The vehicle is according to one embodiment equipped with one identity code that is unique for each vehicle. The charging station and vehicle unit measures outgoing and incoming charging energy, respectively, which are compared to be able to keep book of the cost of the charging in a correct way and to discover manipulation of the charging system and at such occasion make measures such as automatically interrupting the ongoing charging.

The invention solves the problem of monitoring the charging procedure as the charging station according to one embodiment only is activated if the vehicle is successfully identified by the charging station with a code unique for the vehicle. Subsequently the outgoing charging energy from the charging station and the incoming charging energy to the vehicle are measured, and these measured values are constantly being compared. At deviations above a certain threshold value, the charging is interrupted and the charging station is blocked. Identification and activation of the charging station is according to one embodiment made automatically without user intervention. The identification and activation is according to another embodiment initiated by the user, the user may then press a dedicated button adapted to activate the system, or simply plug in the charging cable which will then activate the system.

The invention also solves the problem that the customer traditionally has to initiate or perform payment on the spot when refueling. Thanks to the below described features of the invention it is possible to secure that the cost for the energy transferred from the charging station to the vehicle is charged the correct physical or legal person automatically via e.g. the customers usual monthly account for electrical energy—independent of where the charging is performed.

Preferred embodiments are set forth in the dependent claims and in the detailed description.

### SHORT DESCRIPTION OF THE APPENDED DRAWINGS

Below the invention will be described in detail with reference to the appended drawings, of which:

FIG. 1 shows a plan diagram of how the charging system is structured. This is only a description of how the invention is intended to function; it is thus not an exact technical drawing of the invention.

FIG. 2 illustrates signals that may be communicated in the system according to one embodiment.

FIG. 3 shows a flowchart of a method according to one embodiment of the invention.

FIG. 4 shows a flowchart of a method according to another embodiment of the invention.

### DETAILED DESCRIPTION OF PREFERRED EMBODIMENTS OF THE INVENTION

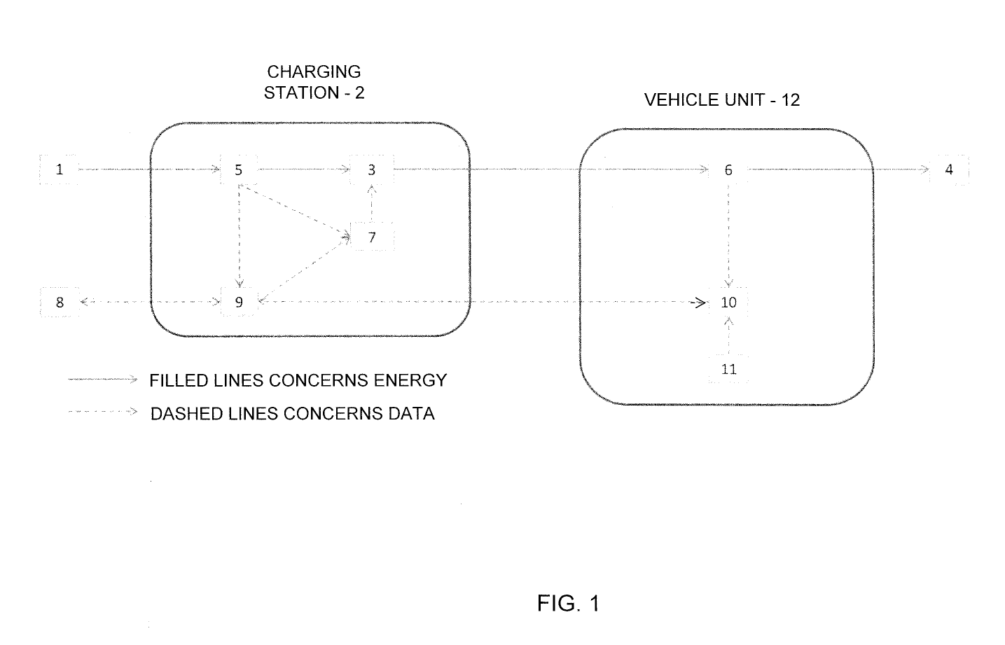

The invention will now be described with reference to FIG. 1. According to the invention both the charging energy that is outgoing from the main power supply 1 via the charging station 2, and the charging energy that is incoming to the vehicle and its associated energy accumulator 4, are measured. These energies do not have to be measured exactly, instead estimated current or voltage measurement may suffice, as will be described in detail further below. The charging side, by means of a communication unit 9, and the receiver side, by means of a communication unit 10, then communicates continuously and compares the consumed and received charging energy. The comparison may be made by a simple differential calculation 7, where Eₒᵤₜ−Eᵢₙ=E_{diff}·Eᵢₙ is the charging energy that the vehicle unit 12 measures with the energy meter 6, Eₒᵤₜ is the charging energy the charging station 2 measures with the energy meter 5 and E_{diff} is the difference. Eₜₕᵣ is the greatest allowed value, the threshold value. At unaffected charging, then E_{diff}<Eₜₕᵣ. At manipulation of the charging system, for example if the charging cable is transferred from the vehicle being charged to another vehicle, E_{diff} will increase rapidly as Eᵢₙ will be zero, or almost zero, and will exceed Eₜₕᵣ. The charging station 2 may then automatically interrupt the charging, for example by means of a circuit breaker 3 of a relay-type. The charging does not have to be carried through by means of a cable for the energy transfer; the system thus works even for other kinds of energy transfer, for example charging via induction.

The system advantageously identifies every vehicle unit 12, to which a vehicle is connected and that intends be charged by one for the purpose intended charging station 2, by a unique identity 11. The identity 11 does not have to be known in advance, but is known in most cases. The identification and data exchange may be made both by means of cable and/or with so called wireless technology. The unique identity 11 makes the process in the above-described part possible and makes it possible to book expenses that emerge in connection with the energy consumption that the charging energy source side sees, in one database 8 connected to the system for later debiting of the emerged expenses. Also the identity 11 is stored in a database 8 to make it possible to give only approved identities access to the charging energy.

### DEFINITIONS AND EXPLANATIONS OF USED EXPRESSIONS AND TERMS

Charging energy source side—the part of the system that provides the energy that shall be transferred to the vehicle on the charging energy receiver side.

Charging energy receiver side—the part of the system of the vehicle that shall be charged.

Eₒᵤₜ—the energy that is outgoing from the charging energy source side.

Eᵢₙ—the energy that is incoming to the charging energy source side.

E_{diff}—the difference between Eₒᵤₜ and Eᵢₙ·E_{diff}=Eₒᵤₜ−Eᵢₙ.

Eₜₕᵣ—the transfer of energy is impaired with losses, these losses will result in a difference

E_{diff} as defined above. Eₜₕᵣ is the threshold value that E_{diff} is compared to in order to decide if the charging continues in a desired way.

### Included Parts

In the system the following parts typically are part of or cooperates with the system:

### On the Charging Energy Receiver Side

Vehicle unit 12: Comprises energy meter 6, communication unit 10 and unique ID 11.

Communication unit 10: Manages communication with the charging energy source side and sends data concerning vehicle identity 11 and measured Eᵢₙ to the communication unit 9.

Energy meter 6: Measures the received energy Eᵢₙ to the energy accumulator 4 and provides data concerning the received energy to the communication unit 10.

Unique ID 11: One for each vehicle unit 12 unique ID which is communicated to the charging energy source side via the communication unit 10.

Energy accumulator 4: An accumulator for energy, for example a battery for storage of electrical energy.

### On the Charging Energy Source Side

Charging station 2: Comprises energy meter 5, circuit breaker 3, differential calculator 7 and communication unit 9.

Communication unit 9: Manages communication with the vehicle unit 12 via its communication unit 10 and sends data from the vehicle unit to the differential calculation 7 about measured Eᵢₙ and communicates data concerning identity for possible approval of the identity and makes charging possible, and then also measured Eₒᵤₜ received from the energy meter 5 with the centrally placed database 8.

Energy meter 5: Measures the delivered energy to the charging energy receiver side from the main supply net 1 to the charging station 2 and provides the data to the differential calculation 7 and the communication unit 9.

Circuit breaker 3: Blocks the charging energy source side from delivering energy in case of lacking approved ID or on such signal from the differential calculation 7.

Differential calculation 7: Here the calculation Eₒᵤₜ−Eᵢₙ=E_{diff} is made, and it is checked if E_{diff}>Eₜₕᵣ where the result is used to decide if the charging shall be continued or shall be interrupted by means of a signal S_{B} to the circuit breaker 3. Data is received over Eᵢₙ from the communication unit 9 and data over Eₒᵤₜ from the energy meter 5. The differential calculation 7 may instead be referred to as a differential calculation unit 7.

Database 8: Typically contains data about vehicle identities, their used charging energy and connects the identity with a person or an account. Receives data about Eₒᵤₜ and identity from the charging station 2 via communication unit 9 and sends possible approval of identity via the same.

Main supply net 1: A power supply system which provides electrical energy to the charging station 2.

### AN EXAMPLE OF THE INVENTION

Person X drives his vehicle A, an electrical hybrid of the plug-in-type, to the parking space and plans to park the vehicle there for about eight hours and will during this time charge his vehicle. Person X drives up to a free parking space with accompanying charging station. A few meters from the target, the charging station and vehicle A gets in contact with each other by means of wireless communication. A unique identification number is sent to the charging system. The vehicle is accepted as customer after the charging station has communicated the identification number to a database which has controlled that the identity is approved and thereafter an indicating lamp on the charging station is turned on to signal that charging of the approved vehicle may start. X steps out of his vehicle and plugs in the charging cable, whereby the charging commences. This continues for about two hours until person Y who has parked his vehicle B on the neighbouring parking space takes out the charging cable and puts it in his own vehicle, with the intention to steel energy that vehicle A is debited for. The charging is interrupted when a difference, which exceeds a threshold, now is detected by the system between the charging energy which is outputted from the charging station and the energy which is inputted to the vehicle A. Person Y is gone for about two hours and puts the charging cable back in place in vehicle A before he leaves. No charging has been made of vehicle B during the two hours. The charging station has tried to resume charging of vehicle A at regular intervals during the two hours without success. When Y puts back the charging cable in vehicle A, the charging is resumed almost immediately because there is now no difference in energy between the energy that is outputted from the charging station and the energy which is inputted to vehicle A. When person X after eight hours comes back he interrupts the charging, the vehicle A has been charged during six hours. The cost for this charging is automatically transferred to person X's monthly electrical energy account via the charging station which communicates the value of the consumed charging energy to it and the identity of the charged vehicle to a database which connects the value of the consumed charging energy and the identity to a database which in turn connects the identity with a registered person and books the cost on his account.

According to one embodiment, the invention comprises an electrical energy charging system for a vehicle comprising a charging station 2 on a charging energy source side and a vehicle unit 12 on a charging energy receiver side. The system further comprises an identification system configured for identification of a charging energy receiver identity 11, a charging energy meter system comprising a first energy meter 3 on the charging energy source side and a second energy meter 6 on the charging energy receiver side configured for measuring outgoing charging energy Eₒᵤₜ from the charging energy source side and incoming charging energy Eᵢₙ to the charging energy receiver side. The energy meters 3, 6 are constructed such that they create communicateable values comparable to each other and that they provide a reasonable estimation of the momentarily transferred energy. The electrical energy charging system further comprises a communication system configured for transfer of the charging energy receiver identity 11 and continuous transfer from the charging energy receiver side to the charging energy source side of data regarding amount of measured incoming charging energy on the charging energy source side for comparison with the outgoing charging energy measured at the charging energy source side, wherein the result of this comparison is decisive whether the charging energy source side shall continue to provide energy to the charging energy receiver side or not. Thus, a manipulation proof system for charging a vehicle is achieved.

According to one embodiment, the system further comprises a database system comprising a database 8 whereto data containing information about charging energy receiver side identities 11 and their respectively charging energy consumption originating from the identification system and the energy meter system are configured to be sent via the communication system for verification of charging energy receiver identities 11 and storage of transferred data. Thus, a vehicle may be verified such that a correct account is debited for the charging. According to another embodiment, the vehicle unit 12 is adapted to store data concerning how much charging energy that has been transferred to the vehicle. Accordingly, it will be easier to detect errors and to find out if someone else actually has imitated an existent vehicle unit 12.

According to another embodiment, the comparison is achieved by calculating E_{diff}=Eₒᵤₜ−Eᵢₙ, and if E_{diff} is greater than a predetermined energy threshold Eₜₕᵣ, then the charging station 2 is blocked from delivering energy to the vehicle unit 12. Accordingly, it is monitored if the charging process is manipulated with.

According to one embodiment, the charging energy data and identification data 11 are adapted to be transferred wirelessly between the charging energy source side and the charging energy receiver side. According to another embodiment, the charging energy data and identification data 11 are adapted to be transferred via a cable.

According to one embodiment, the charging energy receiver identity 11 is unique for every charging energy receiver. Thus, it is possible to identify every vehicle by the charging energy receiver identity. According to another embodiment, the charging energy receiver identity 11 is linked to one or a specific group of unique legal and/or physical persons. Thus, it is possible to debit the charging on an account belonging to said person or group of persons.

According to one embodiment, the charging energy is transferred via a cable or by means of induction when charging. The charging energy data and identification data 11 are according to another embodiment transferred via the same cable that is used for transfer of energy to the vehicle. Thus, the need for additional communication means such as more cables or wireless connection means is obviated.

According to one embodiment, the database system comprises verified charging energy receiver identities, thus vehicle unit identities, for verification of charging energy receiver identities 11. According to another embodiment, the database system is adapted to transmit verified charging energy receiver identities 11 in the database system to the charging station 2, and the charging station 2 is adapted to store locally said transmitted verified charging energy receiver identities 11 for local verification of charging energy receiver identities 11. The charging station 2 then comprises a memory to store the identities 11 and a processor to perform the verification etc. Accordingly, the charging station 2 may reduce the number of times it establishes a connection to the database 8, and does not have to be dependent upon a functioning connection to the database 8.

According to one embodiment, the charging station 2 is adapted to communicate and exchange data with other charging stations 2. By communicating between charging stations 2 instead of between each charging station 2 and the database 8, data communicated between the charging stations 2 and the database may be reduced. The system may comprise a master station which controls communication with the database 8 for a group of charging stations 2. The charging stations 2 may be adapted to communicate with each other wirelessly or via a cable.

By communicating with each other, the system may become more robust and/or simplified in certain cases. For example, one or more vehicle units 12 may get in contact with two or more charging stations 2 at the same time, and to then faster decide which of the charging stations 2 that charges a specific vehicle, the charging stations 2 exchanges certain information about their respectively status. Another example is that the wireless communication part, if present, in a charging station 2 may break down or simply has a poor contact with a certain vehicle unit 12. If neighbouring charging stations 2 then are able to communicate with each other, then another charging station 2 may possibly take over the communication with the vehicle unit 12, even if the energy measurement is still made in the first charging station 2. The same thing may take place if the vehicle owner plugs in the charging cable in the wrong charging station 2, thus a charging station 2 that has not established direct contact with the vehicle unit 12, without discovering the mistake. Also in this case the charging stations 2 may be adapted to cooperate to provide for charging of the vehicle in question.

According to one embodiment, the database system comprises a monitoring unit adapted to monitor if the charging system is tampered with, for example monitor if the same charging energy receiver identity is charging at more than one location at the same time or is charging several times within unreasonable short intervals. In such case, the charging is stopped.

To make it difficult to manipulate the system, data sent between the vehicle unit 12 and the charging station 12 and/or the database system comprising a database 8 is according to one embodiment encrypted, especially when communicating wirelessly. Without encryption it is uncertain if a vehicle unit 12 really is the vehicle unit that it claims to be. If the data communication not encrypted it is easy intercept and in the long run imitate.

According to one embodiment, Bluetooth® is used for communication. With Bluetooth® it is usually possible to communicate with up to seven units directly, which may be used for reducing hardware costs. A centrally located charging station suffices with other words to handle communication and charging of several vehicles with their accompanying vehicle units 12.

At the first contact between a charging station 2 and a vehicle unit 12, a charging energy receiver identity 11 is sent from the vehicle unit 12 to the charging station 2. Thereafter the charging station 2 and the vehicle unit 12 tries to reach an encrypted communication state and to do that they each need an identical encryption key. This key may be stored in a memory (e.g. EEPROM) in the vehicle unit 12. The charging station 2 on the other hand has to check the key against a database, as the key is unique for every vehicle unit 12. The necessary communication between the charging station 2 and the database also has to be encrypted, as well as data that possible is stored locally to accelerate verification of vehicle units 12. Locally stored data is for example verified charging energy receiver identities 11 and their thereto belonging encryption keys, not verified charging energy receiver identities, user preferences for various accounts (e.g. not charging during certain hours etc.) and data about performed charges. For the encrypted communication between the charging station 2 and the database 8, an encryption key is preferably stored in a memory, e.g. EEPROM, in the charging station 2. All data that is sent between charging station 2 and database 8 may be buffered and/or compressed to reduce the amount of data and the number of times a connection to the database has to be made. To reduce the load on the database 8 communication may be allowed certain times during the day or certain days for different charging stations 2. Also for the purpose of robustness data may be buffered, and at a communication interruption data may simply be sent at a later time.

Other communication protocols may instead be used, such as Zigbee, or CAN, Controller Area Network (for wired communication), or RS-485 (a wireless communication protocol).

A straight-forward way to transfer measured data is to measure the energy in an interval and thereafter immediately send the measured energy. If e.g. every interval is five seconds, then less then five seconds is needed to e.g. measure the received energy in the vehicle and then send the received energy to the charging station 2. If a very fast-responding system is needed, then it is needed to measure the energy very often in small intervals and to timestamp the measurements to be able to make a correct and fast comparison of the outgoing and incoming energy. If the wireless communication is lost during a limited time, it is then easy to continue calculations and comparisons where the disruption occurred. If Bluetooth® is used, then an amount of data is automatically sent, and a so-called link is created between the charging station 2 and the vehicle unit 12. It is then not needed to explicitly send charging energy receiver identity 11 with every data package; instead it suffices with e.g. the amount of received energy the latest time period, e.g. five seconds.

The vehicle owner will pay for electrical energy. Electrical energy may be expressed as current·voltage·time. The present system advantageously continuously measures the energy that is outgoing from the charging station 2 and the energy that is incoming to the vehicle, and compares the energies. To get correct values of the energy, both voltage and current must be measured continuously. This is how the measurement of energy preferably is made on the charging station 2—side to be able to debit the user the correct amount.

However, on the vehicle unit 12—side the energy may be estimated by only measuring the current, as this measurement may be used for determining if the system is manipulated and is thus not a ground for payment. It will then be detected if someone has connected parallel to the vehicle unit 12, or if the cable is damaged. If only the voltage is measured to detect manipulation with the charging, then it is not discovered if someone has connected parallel with the vehicle unit 12, which is the most obvious way to connect to the vehicle unit 12 to steel energy from an ongoing charging process. Damage to the cable will on the other hand be detected, as a damage will probably cause a voltage drop.

A current may be measured in a circuit by connecting an amperemeter in series to the circuit. Such an amperemeter should preferably have as low inner resistance as possible to stop heat from developing and not affect measuring objects more than necessary. Earlier moving coil instruments were used; in the present invention a digitally implemented amperemeter is preferred.

According to another embodiment, alternating current (AC) or direct current (DC) in a cable is measured without connecting in series, by measuring the magnetic flux from the cable. A pincer-like device is then clasped around the cable. The device is made of a magnetic material and forms the core in a transformer where the cable that is measured also constitutes primary coil. By means of a coil that is wound around the inner part of the device it is made possible to indirectly read-off the current in the cable. When DC is measured, the Hall-effect is used.

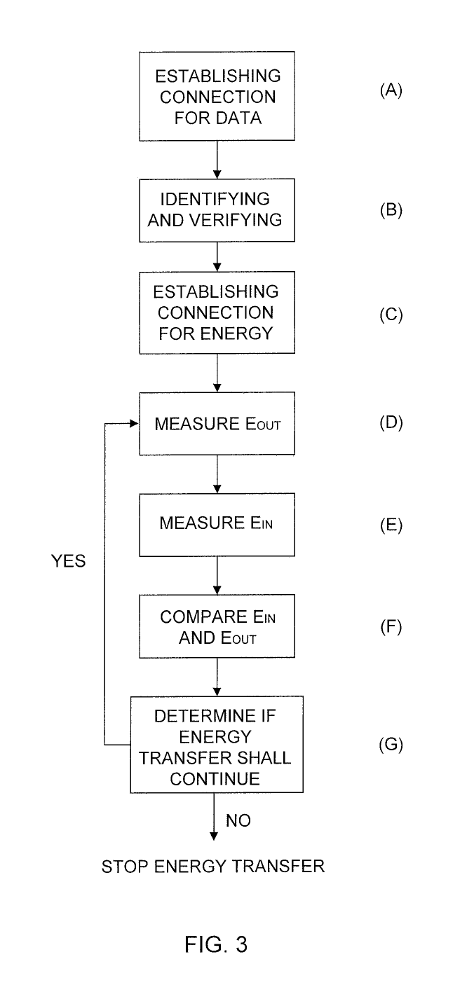

The invention also relates to a method for charging a vehicle provided with a vehicle unit 12 with electrical energy from a charging station 2. The method according to one embodiment is illustrated by the flowchart in FIG. 3, and comprises the steps of: A) establishing a data communication connection between said charging station 2 and the vehicle unit 12; B) identifying and verifying a charging energy receiver identity 11 belonging to the vehicle unit 12; C) establishing connection between the charging station 2 and the vehicle for transfer of energy from the charging station 2 to the vehicle; and during transfer of energy, to: D) measure outgoing charging energy Eₒᵤₜ from the charging station 2; E) measure incoming charging energy Eᵢₙ to the vehicle; F) compare the outgoing charging energy Eₒᵤₜ to the incoming charging energy Eᵢₙ; and G) determine if the transfer of energy shall continue based upon the comparison. Accordingly, a manipulation proof method for charging a vehicle is achieved. Step D) and E) are according to one embodiment performed simultaneously. This method as illustrated in FIG. 3 is only one of a plurality of possible methods for charging a vehicle according to the invention.

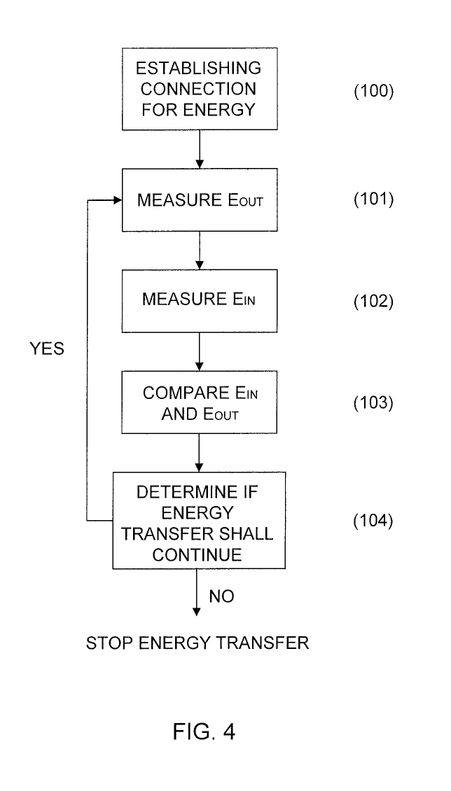

The invention relates according to one embodiment to a method for charging a vehicle provided with a vehicle unit 12 with electrical energy from a charging station 2, the method is illustrated in FIG. 4 and comprises: 100) establishing a connection between the charging station 2 and the vehicle for transfer of energy from the charging station 2 to the vehicle; and during transfer of energy, to 101) measure outgoing charging energy Eₒᵤₜ from the charging station 2; 102) measure incoming charging energy Eᵢₙ to the vehicle unit 12; 103) compare the outgoing charging energy Eₒᵤₜ to the incoming charging energy Eᵢₙ; and to 104) determine if the transfer of energy shall continue based upon the comparison. Step 101) and 102) are according to one embodiment performed simultaneously. Thus, another method for detecting manipulation is achieved.

According to one embodiment, the method further comprises: —establishing a data communication connection between the charging station 2 and the vehicle unit 12; and —identifying and verifying a charging energy receiver identity 11 belonging to the vehicle unit 12;

According to another embodiment, the method further comprises to store data of how much charging energy that has been transferred to the identified and verified vehicle in a database 8. Thus, data about the charging can be saved and an account connected to the identity of the vehicle may be debited the cost for the performed charging. According to another embodiment, the method comprises storing data concerning how much charging energy that has been transferred to the vehicle in a memory in the vehicle unit 12. Accordingly, it will be easier to detect errors and to find out is someone else actually has imitated an existent vehicle unit 12.

According to another embodiment, the method comprises blocking the charging station 2 from delivering energy in case of not verified charging energy receiver identity 11 and/or if it is determined that the transfer of energy shall not continue. According to one embodiment, the method comprises calculating E_{diff}=Eₒᵤₜ−Eᵢₙ, and if E_{diff} is greater than a predetermined energy threshold Eₜₕᵣ, it is determined that the transfer of energy shall not continue and the charging station 2 is blocked from delivering energy.

According to one embodiment, the method comprises communicating charging energy data and identification data 11 wirelessly or via a cable between the charging station 2 and the vehicle unit 12.

According to another embodiment, the method comprises transferring energy from the charging station 2 to the vehicle via a cable or by means of induction. The charging energy data and identification data 11 may be transferred via the same cable that is used for transfer of energy to the vehicle. Thus, the need for communication via other means such as more cables or wireless connection means is obviated.

According to one embodiment, the charging energy receiver identity 11 is connected to one or a specific group of unique legal and/or physical persons, and the method comprises debiting used charging energy on the person or the account. According to one embodiment, the method comprising verification of charging energy receiver identities 11 with verified charging energy receiver identities, thus vehicle unit identities, in the database 8.

According to one embodiment, the method comprises transmitting verified charging energy receiver identities 11 in the database 8 to the charging station 2, and storing locally the transmitted verified charging energy receiver identities 11 for local verification of charging energy receiver identities 11.

According to one embodiment, the method comprises communicating and exchanging data with other charging stations 2.

According to one embodiment, the method comprises monitoring if the charging is tampered with, for example monitoring if the same charging energy receiver identity 11 is charging at more than one location at the same time or is charging several times within unreasonable short intervals.

According to one embodiment, the method comprising encrypting data between charging station 2, vehicle unit 12 and/or the database system 8.

The invention further relates to computer-readable medium comprising computer program instructions, that, when executed by a data processor in e.g. the charging station 2 or in the vehicle unit 12, performs any of the steps of the above described method. The invention also relates to a computer program product comprising the computer program instructions.

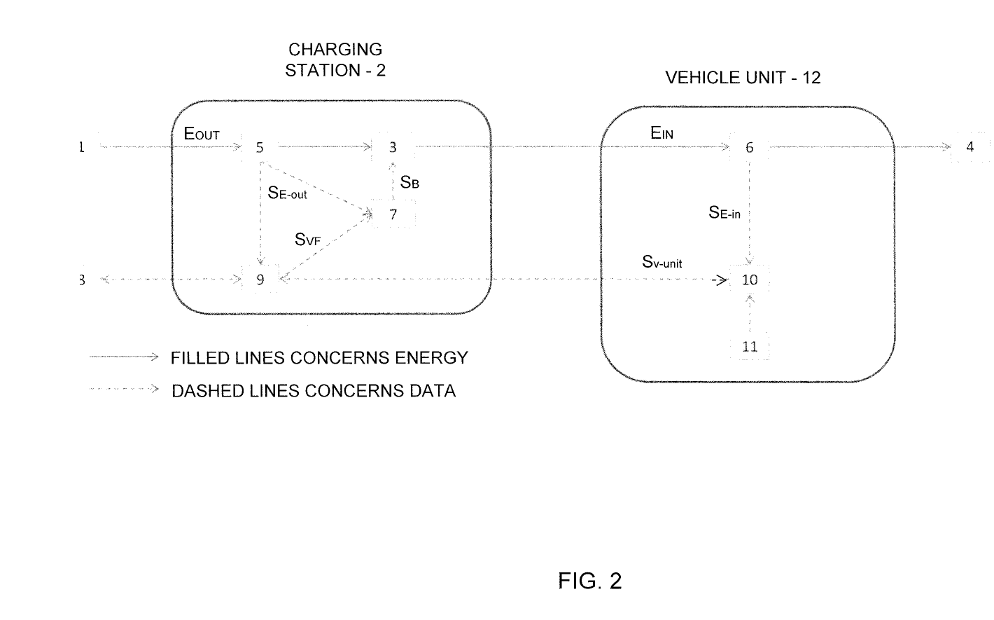

The invention further relates to a charging station 2 for electrical charging of a vehicle. The charging station 2 is shown in FIGS. 1 and 2, and the signals described below are illustrated in FIG. 2. The charging station 2 comprises according to one embodiment a first energy meter 5 adapted for measuring outgoing charging energy Eₒᵤₜ from the charging station 2 and for producing an outgoing charging energy signal S_{E-out} dependent thereon; a communication unit 9 adapted for receiving a charging energy receiver identity 11 indicating a unique identity of a vehicle unit 12 belonging to the vehicle, and for receiving a vehicle unit signal Sᵥ₋ᵤₙᵢₜ dependent on incoming charging energy Eᵢₙ to the vehicle unit 12. The charging station 12 further comprises an identification system adapted for verifying the charging energy receiver identity 11, and for producing a verification signal S_{VS} indicating if the identity 11 is verified. The charging station 2 is further adapted to decide if it shall continue to charge the vehicle dependent upon a comparison between Eₒᵤₜ and Eᵢₙ and/or the verification signal S_{VS}. Accordingly, a charging station 2 is achieved which can decide if a charging is manipulated with. Thus, a secure charging may be performed.

According to one embodiment, the charging station 2 comprises a first energy meter 5 configured to measure outgoing charging energy Eₒᵤₜ from the charging station 2 and to produce an outgoing charging energy signal S_{E-out} indicating thereof; a communication unit 9 configured to receive a vehicle unit signal S_{V-unit} from a vehicle unit 12 dependent on incoming charging energy Eᵢₙ to the vehicle; wherein the charging station 2 is further adapted to decide if it shall continue to charge the vehicle as a function of a comparison between Eₒᵤₜ and Eᵢₙ indicating a difference between the same. Thus, it is the difference between Eₒᵤₜ and Eᵢₙ that determines if the charging shall be continued or not.

According to another embodiment, the communication unit 9 is configured to receive a charging energy receiver identity 11 indicating a unique identity of a vehicle unit 12 belonging to the vehicle; the charging station 2 further comprises an identification system adapted for verifying the charging energy receiver identity 11; and for producing a verification signal S_{VF} indicating if the identity 11 is verified; the charging station 2 is further adapted to decide if it shall continue to charge the vehicle as a function of the verification signal S_{VF}.

According to one embodiment, the charging station 2 further comprises a database 8 whereto data about charging energy receiver side identity 11 and their respectively charging energy consumption are sent via the communication system for verification of charging energy receiver identities 11 and storage of transferred data. Thus, the identity of the vehicle that intends to be charged can be verified, such that the correct account may be debited for the charging of the vehicle.

According to one embodiment, the comparison is achieved by calculating E_{diff}=Eₒᵤₜ−Eᵢₙ, and if E_{diff} is greater than a predetermined energy threshold Eₜₕᵣ, then the charging station 2 is blocked from delivering energy. According to one embodiment, the charging station 2 comprises a calculation unit adapted to calculate the comparison. Thus, the comparison may be made in the charging station 2. The comparison may instead be made in another unit such as the vehicle unit 12, and then the vehicle unit signal Sᵥ₋ᵤₙᵢₜ is indicating the comparison.

According to one embodiment, the charging station 2 comprises a circuit breaker unit adapted to block the charging station 2 from charging the vehicle if the identity 11 is not verified or if E_{diff} is greater than Eₜₕᵣ. The charging station 2 may instead comprise another kind of unit or function to interrupt or not start charging the vehicle.

According to one embodiment, the charging station 2 is adapted to communicate signals wirelessly or via a cable. According to one embodiment, the charging station 2 is adapted to transfer energy via a cable or by means of induction. The cable for communicating signals and the cable for transfer of energy is according to one embodiment the same.

According to one embodiment, the charging energy receiver identity 11 is connected to one or a specific group of unique legal and/or physical persons, and the identification system is adapted to debit the used charging energy on the person or the person's account. According to one embodiment, the database 8 comprises verified charging energy receiver identities, thus vehicle unit identities, for verification of charging energy receiver identities 11.

According to one embodiment, the charging station 2 is adapted to transmit verified charging energy receiver identities 11 in the database 8 to the charging station 2, and to store locally the transmitted verified charging energy receiver identities 11 for local verification of charging energy receiver identities 11.

According to another embodiment, the charging station 2 is adapted to communicate and exchange data with other charging stations 2.

To be able to identify if the charging system has been manipulated with, the database 8 is according to one embodiment subject for automatic database checks. If someone wants to steel energy, one way to do this is by imitating an existing vehicle identification, thus a charging energy receiver identity 11, and thereby get authorization from a charging station 2 to charge a vehicle. To be able to monitor the charging process to detect manipulation, each vehicle unit 12 has got a unique charging energy receiver identity 11, and preferably also each charging station 2 has got a unique identity. According to one embodiment, the identification system comprises a monitoring unit adapted to monitor if the charging is tampered with, for example monitor if the same charging energy receiver identity 11 is charging at more than one location at the same time or is charging several times within unreasonable short intervals. This monitoring can be made when the charging is in progress or after the charging process is finished. According to one embodiment, to facilitate monitoring, each vehicle with a vehicle unit 12 and/or charging station 2 belongs to a home region, which provides the possibility to indicate behaviours which are considered to be suspicious. By making the database indicate suspicious behaviour with a flag, the database may be adapted to alarm the user and/or system owner when a certain number of flags have been raised. The user or system owner may then make a manual check to see what is wrong. The alarm may be in the shape of a SMS or e-mail to the owner of the vehicle. A suspicious behaviour may be an unusual increase of the number of charging occasions and/or the size of the charging, and within which time period and at which geographical location the charging is made. The monitoring unit is thus preferably adapted to keep track on the number of chargings each charging energy receiver identity 11 is associated with, the size of each charging etc.

According to a still further embodiment, the charging station 2 is adapted to encrypt data between the charging station 2, the vehicle unit 12 and/or the database system.

The invention also relates to a vehicle unit 12, which according to one embodiment comprises a second energy meter 6 for measuring incoming charging energy Eᵢₙ to the vehicle unit 12, and for producing an incoming charging energy signal S_{E-in} dependent thereon; the vehicle unit further comprises a charging energy receiver identity 11 unique for the vehicle unit 12 and a communication unit 10 configured for transfer of the charging energy receiver identity 11 and a vehicle unit signal Sᵥ₋ᵤₙᵢₜ dependent on the incoming charging energy signal S_{E-in} to a charging station 2. The vehicle unit 2 is shown in FIGS. 1 and 2, and the signals described are illustrated in FIG. 2. Accordingly, a vehicle unit 12 is achieved that can be used in a vehicle as an interface between the accumulators 4 in the vehicle and a charging station 2.

According to another embodiment, the vehicle unit 12 comprises a second energy meter 6 configured for measuring incoming charging energy Eᵢₙ to the vehicle unit 12, and for producing an incoming charging energy signal S_{E-in} indicating thereof, and a communication unit 10 configured for transfer of a vehicle unit signal Sᵥ₋ᵤₙᵢₜ dependent on the incoming charging energy signal S_{E-in} to a charging station 2.

According to a further embodiment, the vehicle unit 12 comprises a charging energy receiver identity 11 unique for the vehicle unit 12, wherein the communication unit 10 is configured to transfer the charging energy receiver identity 11 to a charging station 2.

According to one embodiment, the vehicle unit 12 is adapted to receive an outgoing charging energy signal S_{E-out} indicating outgoing charging energy Eₒᵤₜ from a charging station 2, and comprises a calculation unit adapted to compare the outgoing charging energy signal S_{E-out} with the incoming charging energy signal S_{E-in} wherein the vehicle unit signal Sᵥ₋ᵤₙᵢₜ is indicating the comparison. Thus, the calculation for comparing may be made in the vehicle unit 12.

According to another embodiment, the vehicle unit signal Sᵥ₋ᵤₙᵢₜ is the incoming charging energy signal S_{E-In}. Thus, the comparison may be made external to the vehicle unit 12, e.g in a charging station 2.

According to another embodiment, the vehicle unit 12 is adapted to store data concerning how much charging energy that has been transferred to the vehicle that is identified by the vehicle unit 12. Accordingly, it will be easier to detect errors and to find out if someone else actually has imitated the vehicle unit 12.

According to one embodiment, the vehicle unit 12 is adapted to communicate signals wirelessly or via a cable.

The charging station 2 and the vehicle unit 12 preferably comprises processing means such as CPU:s and memory means to be able to perform the described communication, calculations, comparisons, measurements etc. The vehicle unit 12 may according to one embodiment use already existing devices in the vehicle, such as CPU:s, memory means, energy measurement means etc, to perform communication, calculations, comparisons, measurements etc.

The different parts in the system are advantageously protected against overshoots and other disturbances originating from e.g. strokes of lightning, disturbances on the main supply network, incorrect voltage values etc. by galvanically separating the vehicle unit 12 from accumulators and electronics in the vehicle by means of e.g. transformers or other kinds of protection electronics. The charging unit 2 is advantageously protected in a similar way.

The vehicle unit 12 is according to one embodiment formed as a unit adapted to be built-in in a vehicle. The vehicle unit 12 and the charging unit 2 preferably comprise an antenna each to be able to communicate wirelessly. The antenna connected to the vehicle unit 12 may e.g. be located in the grille, as the antenna should not be shielded behind metal to work well.

The vehicle unit 12 need some kind of power supply to function, and is according to one embodiment adapted to be powered from the accumulators in the vehicle. The vehicle unit 12 is according to one embodiment adapted to communicate with other control units, for example ECU:s (Electronic Control Units), to control different vehicle functions in dependence of the charging system. For example, a cable for charging may be adapted to be locked in place in the vehicle at the same time as the central locking of the vehicle is actuated. Another example is the case when the cable for charging is put in place for charging, it should not be possible to start the vehicle, or at least an alarm should sound if the vehicle is started.

The system is according to one embodiment adapted to also debit parking time. The charging station 2 is then adapted to identify the vehicle unit 12 and to measure for how long time the vehicle comprising the identified vehicle unit 12 is located on the dedicated parking spot. The measured time corresponding to a cost is then booked to an account belonging to the identity of the vehicle unit 12 and debited.

It is advantageous to give feedback about the charging process to the user, as the user is aware of the status of the charging process and can e.g. make choices dependent thereupon. The feedback information may be communicated from the vehicle unit 12 or the charging station 2. Feedback may be given in different ways, as will be explained below.

According to one embodiment, feedback about the charging process is given via one or several diodes to show status for the charging process or indicate errors. For example may a colour coding be used to give feedback, where different status for the charging process are: OK to charge, NOT OK to charge, charging is started, charging is ready and was finished correctly and charging is disrupted because of fault.

According to another embodiment, more advanced feedback is given by means of a display on the charging station and/or in the vehicle that is charged, e.g. on the instrument panel. It is then possible to give explanations and information in plain language or in pictures to the user, for example explanations and information about which vehicle that is connected, status for charging, statement of account etc.

According to a further embodiment, feedback is given via electronic communication to a mobile unit such as a mobile phone or computer, e.g. via Bluetooth®, e-mail, SMS or any other suitable communication. Example of feedback may be the same as explained above, but also more private information such as charging history, payment information, warning messages, error messages etc.

The vehicle identity, i.e. the charging energy receiver identity, is according to one embodiment connected to certain conditions such that charging during certain hours, or charging when it is decided that there is a lot of electricity in the main supply network. These conditions may be registered in the database and initiated and/or adjusted via an interface e.g. a website connected to the database via internet. The conditions may instead be saved in a memory in the vehicle unit 12, and may be adjusted via an interface.

In the case when several vehicles are located close to each other for charging from different charging stations 2 and a charging station 2 is communicating wirelessly with the vehicle units 12 in the vehicles, the charging station 2 might need to sort out the closest vehicle to know which vehicle that should to be charged, and to establish a connection to the vehicle unit 12 for identification of the vehicle. The charging station 2 is according to one embodiment adapted to find the closest vehicle by communicating in a limited range, for example only vehicles that are within one meter from the charging station 2 will come in question for being identified and charged. According to another embodiment, the strength of the signals from the vehicle unit 12 may be used to determine which vehicle that is closest to the charging station 12. Signal strength of signals from different vehicle units 12 are then measured, and the vehicle comprising the vehicle unit 12 that emits signals with the greatest strength is considered to be the vehicle closest to the charging station 2. According to another embodiment, the charging station 2 is adapted to measure how long time it takes for signals to be communicated to the different vehicles, respectively. The vehicle to which shortest communication time is needed is then selected as being the vehicle closest to the charging station 2.

The invention also relates to a method for electrical charging of a vehicle from a charging station 2. The method comprises: A1) measuring outgoing charging energy Eₒᵤₜ from the charging station 2 and producing an outgoing charging energy signal S_{E-out} dependent thereon; B1) receiving a charging energy receiver identity 11 indicating a unique identity of a vehicle unit 12 belonging to the vehicle, and receiving a vehicle unit signal Sᵥ₋ᵤₙᵢₜ dependent on incoming charging energy Eᵢₙ to the vehicle unit 12; C1) verifying the charging energy receiver identity 11, and producing an verification signal S_{VS} indicating if the identity 11 is verified; D1) deciding if the charging shall be continued dependent upon a comparison between Eₒᵤₜ and Eᵢₙ and/or the verification signal S_{VS}. Thus, a method for charging a vehicle from a charging station is achieved, wherein it is monitored if the charging is manipulated with.

According to one embodiment, the method comprises comparing the outgoing charging energy signal S_{E-out} and an incoming charging energy signal S_{E-in} indicating the incoming charging energy Eᵢₙ to the vehicle, and producing the vehicle unit signal Sᵥ₋ᵤₙᵢₜ indicating the comparison.

According to another embodiment, the method comprises calculating comparison in a calculation unit in the charging station.

According to one embodiment, the method comprises blocking the charging station 2 from charging the vehicle if the identity 11 is not verified or if the comparison indicates an energy difference value E_{diff} between the outgoing charging energy signal S_{E-out} and the incoming charging energy signal S_{E-in} above a certain energy threshold value Eₜₕᵣ.

According to one embodiment, the method comprises debiting the used charging energy on a person's or a group of persons' account, wherein the charging energy receiver identity 11 is connected to the person or a group of unique legal and/or physical persons.

According to another embodiment, the method comprises verifying charging energy receiver identities 11 with verified charging energy receiver identities in the database 8.

According to one embodiment, the method comprises transmitting verified charging energy receiver identities 11 in the database 8 to the charging station 2, and storing locally in the charging station 2 the transmitted verified charging energy receiver identities 11 for local verification of charging energy receiver identities 11.

According to one embodiment, the method comprises communicating and exchanging data with other charging stations 2.

According to one embodiment, the method comprises monitoring if the charging is tampered with, for example by monitoring if the same charging energy receiver identity 11 is charging at more than one location at the same time or is charging several times within unreasonable short intervals.

According to one embodiment, the method comprises encrypting data between charging station 2, vehicle unit 12 and/or the database system 8.

The invention also relates to a method for electrical charging of a vehicle comprising a vehicle unit 12. The method further comprises: A2) measuring incoming charging energy Eᵢₙ to the vehicle, and producing an incoming charging energy signal S_{E-in} dependent thereon; B2) transferring of a charging energy receiver identity 11 unique for the vehicle unit 12, and a vehicle unit signal Sᵥ₋ᵤₙᵢₜ dependent on the incoming charging energy signal S_{E-in} to a charging station 2.

According to one embodiment, the method comprises receiving an outgoing charging energy signal S_{E-out} indicating outgoing charging energy Eₒᵤₜ from a charging station 2, and comparing the outgoing charging energy signal S_{E-out} with the incoming charging energy signal S_{E-in} wherein the vehicle unit signal Sᵥ₋ᵤₙᵢₜ is indicating the comparison. Thus, a comparison is made in the charging vehicle unit 12.

According to one embodiment, the vehicle unit signal Sᵥ₋ᵤₙᵢₜ is the incoming charging energy signal S_{E-in}. Accordingly, S_{E-in} is transferred to the charging station 2 for comparison in the charging station 2.

According to one embodiment the invention relates to an electrical energy charging system for a vehicle comprising charging station 2 and database on the charging energy source side and vehicle unit 12 on the charging energy receiver side. The system further comprises an identification system for identification of charging energy receiver identity, a charging energy meter system comprising an energy meter 5 on the charging energy source side and an energy meter 6 on the charging energy receiver side for measuring outgoing charging energy from the charging energy source side and incoming charging energy to the charging energy receiver side wherein the energy meters 5, 6 are constructed such that they create communicative and with each other comparable values and gives a reasonable estimation of the momentarily transferred energy, a communication system for transfer of charging energy receiver identity and continuous transfer from the charging energy receiver side to the charging energy source side of data about the size of measured incoming charging energy on the charging energy source side for comparison with the on the charging energy source side measured outgoing charging energy where the result of this comparison is decisive for if the charging energy source side shall continue to provide energy to the charging energy receiver side and a database system whereto data containing information about charging energy receiver side identities and their respectively charging energy consumption originating from the identification system and the energy meter system are sent via the communication system for verification of charging energy receiver identities and storage of transferred data.

The present invention is not limited to the above-described preferred embodiments. Various alternatives, modifications and equivalents may be used. Therefore, the above embodiments should not be taken as limiting the scope of the invention, which is defined by the appending claims.

1. Electrical energy charging system for a vehicle comprising a charging station (2) on a charging energy source side and a vehicle unit (12) on a charging energy receiver side, characterized in that the system comprises
an identification system configured for identification of a charging energy receiver identity (11);
a charging energy meter system comprising a first energy meter (5) on the charging energy source side and a second energy meter (6) on the charging energy receiver side for measuring outgoing charging energy Eout from the charging energy source side and incoming charging energy Ein to the charging energy receiver side, wherein the energy meters (5, 6) are constructed such that they create communicateable values comparable to each other and that they provide a reasonable estimation of the momentarily transferred energy;
a communication system configured for transfer of the charging energy receiver identity (11) and continuous transfer from the charging energy receiver side to the charging energy source side of data regarding amount of measured incoming charging energy on the charging energy source side for comparison with the outgoing charging energy measured at the charging energy source side, wherein the result of this comparison is decisive whether the charging energy source side shall continue to provide energy to the charging energy receiver side or not.

2. Charging system according to claim 1, wherein the system further comprises a database system comprising a database (8) whereto data containing information about charging energy receiver side identities (11) and their respectively charging energy consumption originating from the identification system and the energy meter system are adapted to be sent via the communication system for verification of charging energy receiver identities (11) and storage of transferred data.

3. Charging system according to claim 1, wherein said comparison is achieved by calculating Ediff=Eout−Ein, and if Ediff is greater than a predetermined energy threshold Ethr, then the charging station (2) is blocked from delivering energy.

4. Charging system according to claim 1, wherein charging energy data and identification data (11) are adapted to be transferred wirelessly between the charging energy source side and the charging energy receiver side.

5. Charging system according to claim 1, wherein charging energy data and identification data (11) are adapted to be transferred via a cable between the charging energy source side and the charging energy receiver side.

6-9. (canceled)

10. Charging system according to claim 2, wherein said database system comprises verified charging energy receiver identities, thus vehicle unit identities, for verification of charging energy receiver identities (11).

11-12. (canceled)

13. Charging system according to claim 2, wherein said database system comprises a monitoring unit adapted to monitor if the charging system is tampered with, for example monitor if the same charging energy receiver identity is charging at more than one location at the same time or is charging several times within unreasonable short intervals.

14. (canceled)

15. Method for charging a vehicle provided with a vehicle unit (12) with electrical energy from a charging station (2), characterized in that the method comprises:
establishing a data communication connection between said charging station (2) and said vehicle unit (12);
identifying and verifying a charging energy receiver identity (11) belonging to said vehicle unit (12);
establishing connection between said charging station (2) and said vehicle for transfer of energy from said charging station (2) to said vehicle; and during transfer of energy, to
measure outgoing charging energy Eout from said charging station (2);
measure incoming charging energy Ein to said vehicle;
compare said outgoing charging energy Eout to said incoming charging energy Ein;
determine if said transfer of energy shall continue based upon said comparison.

16-17. (canceled)

18. Method according to claim 15, further comprising storing data of how much charging energy has been transferred to the identified and verified vehicle unit (12) in a database (8).

19. Method according to claim 15, further comprising blocking the charging station (2) from delivering energy in case of not verified charging energy receiver identity (11) and/or if it is determined that said transfer of energy shall not continue.

20. Method according to claim 15, comprising calculating Ediff=Eout−Ein, and if Ediff is greater than a predetermined energy threshold Ethr, then the charging station (2) is blocked from delivering energy.

21. Method according to claim 15, comprising communicating charging energy data and/or identification data (11) wirelessly between the charging station (2) and the vehicle unit (12).

22. Method according to claim 15, comprising communicating charging energy data and/or identification data (11) via a cable between the charging station (2) and the vehicle unit (12).

23-28. (canceled)

29. Method according to claim 15, comprising monitoring if the charging is tampered with, for example monitoring if the same charging energy receiver identity (11) is charging at more than one location at the same time or is charging several times within unreasonable short intervals.

30. (canceled)

31. A computer-readable medium comprising computer program instructions, that, when executed by a data processor, performs the method according to claim 15.

32-60. (canceled)
